(19) United States
(12) Patent Application Publication
(10) Pub. No.: US 2016/0325416 A1
(43) Pub. Date: Nov. 10, 2016

(54) VALVE SEAL REMOVAL TOOL

(71) Applicants: Hyundai America Technical Center, Inc, Superior Township, MI (US); Hyundai Motor Company, Seoul (KR); Kia Motors Corporation, Seoul (KR)

(72) Inventors: Steven Rathbun, Ypsilanti, MI (US); Jeffrey Hollowell, Commerce, MI (US)

(21) Appl. No.: 14/707,883

(22) Filed: May 8, 2015

(51) Int. Cl. B25B 27/00

(52) U.S. Cl. CPC B25B 27/0028

(57) ABSTRACT

A valve seal removal tool includes: an elongated, threaded rod having a stopper mounted at a proximal end of the rod and a collet connected to a distal end of the rod having an inner circumference capable of being fitted over an outer circumference of a valve seal; a collet holder movable along the longitudinal axis of the rod, and having an inner circumference capable of being fitted over an outer circumference of a proximal end of the collet; a threaded nut coupled to the rod; and a slide hammer slidable along the rod and having a proximal end that opposes the stopper and is operable to slidably contact the stopper. Tightening the nut in a distal direction of the rod causes the nut to contact the collet holder, forcing the collet holder to move over a portion of the collet which compresses the collet.

### BACKGROUND

(a) Technical Field

The present disclosure relates generally to a tool for component removal, and more particularly, to a tool for valve seal removal.

(b) Background Art

Frequently, signs of engine malfunction such as a sputtering engine or an emission of colored smoke are indicative of a faulty valve seal. In such case, removal of the valve seal is necessary in order to install a new valve seal in the engine, which requires some disassembly of the engine to gain access to the valve assembly. As shown in FIG. 1, a conventional valve assembly 100 includes a valve seal 120 attached to a top portion of a valve stem 110. A valve spring 150 is disposed around the valve seal 120, and a valve retainer 140 and valve keepers 130 are disposed substantially atop the valve spring 150. Notably, the valve assembly 100 shown in FIG. 1 is merely a single example of several possible valve assembly configurations.

Problematically, valve seal removal can be a difficult task. Tools for removing the valve seal have been developed, but they are difficult to use due to the force required to grip the valve seal. For instance, a commonly used tool is a pliers-like device that relies on a manual gripping force to remove the valve stem seal. However, this style of tool can damage the cylinder head if used improperly. Moreover, it can be difficult to generate the necessary axial force to remove the valve seal 120 (e.g., by pulling outward), while still gripping the handles to keep the seal engaged.

### SUMMARY OF THE DISCLOSURE

The present disclosure provides a tool for assisting in the removal of valve stem seals. The valve seal removal tool disclosed herein can be pressed over a valve guide for efficient extraction in an internal combustion engine. The valve seal removal tool is capable of being operated by hand. Further, the tool may consist of a collet with a round inner end for engaging the round valve seal, a collet holder, a threaded rod (as a drawbar), a nut that tightens on the collet holder, drawing the collet into the collet holder, and a slide hammer as means of generating the axial force needed to extract the valve seal. The valve seal does not use any gears and, instead, uses compression to hold the valve seal tightly. The nut (e.g., flange nut) is used to apply force to the collet holder, so the slide hammer does not require an open inner end dimension. Then, the slide hammer is used to apply force in the opposite direction to extract the valve seal.

According to embodiments of the present disclosure, a valve seal removal tool includes: an elongated, threaded rod having a stopper mounted at a proximal end of the rod and a collet connected to a distal end of the rod that longitudinally extends along a longitudinal axis of the rod, an inner circumference of the collet capable of being fitted over an outer circumference of a valve seal; a collet holder surrounding a first portion of the rod, positioned substantially to a proximal side of the collet, and longitudinally extending along the longitudinal axis of the rod, the collet holder being movable along the longitudinal axis of the rod and having an inner circumference capable of being fitted over an outer circumference of a proximal end of the collet; a threaded nut coupled to the rod and having a distal end that opposes a proximal end of the collet holder; and a slide hammer surrounding a second portion of the rod and being slidable along the longitudinal axis of the rod, the slide hammer having a distal end that opposes the nut and a proximal end that opposes the stopper and is operable to slidably contact the stopper, thereby generating an axial force in a proximal direction of the rod. Tightening the nut in a distal direction of the rod causes the distal end of the nut to contact the proximal end of the collet holder, forcing the collet holder to move in the distal direction of the rod over a portion of the collet which compresses the collet.

The collet holder may be formed with a tapered inner surface at a distal end thereof.

The tapered inner surface may be formed such that a thickness of a wall portion at a distal end of the tapered inner surface is less than a thickness of a wall portion at a proximal end of the tapered inner surface.

A surface angle of the tapered inner surface may correspond to a surface angle of a tapered outer surface portion of the collet.

When the collet holder is forced to move in the distal direction of the rod, an inner distal surface of the collet holder may abut an outer surface of the collet which compresses the collet.

The outer surface of the collet abutted by the inner distal surface of the collet holder may be conically shaped.

The collet holder may have a cylindrical outer surface. The collet may have a cylindrical proximal outer portion and a conical distal outer portion.

The collet may have a cylindrical inner surface.

The nut may be a flange nut.

A flange portion may be formed at the distal end of the nut that opposes the proximal end of the collet holder.

Furthermore, according to embodiments of the present disclosure, a valve seal removal system includes: a valve assembly including a valve seal connected to a valve; and a valve seal removal tool including: an elongated, threaded rod having a stopper mounted at a proximal end of the rod and a collet connected to a distal end of the rod that longitudinally extends along a longitudinal axis of the rod, an inner circumference of the collet capable of being fitted over an outer circumference of the valve seal; a collet holder surrounding a first portion of the rod, positioned substantially to a proximal side of the collet, and longitudinally extending along the longitudinal axis of the rod, the collet holder being movable along the longitudinal axis of the rod and having an inner circumference capable of being fitted over an outer circumference of a proximal end of the collet; a threaded nut coupled to the rod and having a distal end that opposes a proximal end of the collet holder; and a slide hammer surrounding a second portion of the rod and being slidable along the longitudinal axis of the rod, the slide hammer having a distal end that opposes the nut and a proximal end that opposes the stopper and is operable to slidably contact the stopper, thereby generating an axial force in a proximal direction of the rod. Tightening the nut in a distal direction of the rod causes the distal end of the nut to contact the proximal end of the collet holder, forcing the collet holder to move in the distal direction of the rod over a portion of the collet which compresses the collet onto the outer circumference of the valve seal.

Furthermore, according to embodiments of the present disclosure, a method for removing a valve seal includes: fitting an inner circumference of a collet over an outer circumference of the valve seal, the collet being connected to a distal end of an elongated, threaded rod and longitudinally extending along a longitudinal axis of the rod; tightening a threaded nut coupled to the rod in a distal direction of the rod toward a collet holder surrounding a first portion of the rod and longitudinally extending along the longitudinal axis of the rod, such that the nut contacts a proximal end of the collet holder, forcing the collet holder to move in the distal direction of the rod over a portion of the collet which compresses the collet onto the outer circumference of the valve seal; and sliding a slide hammer surrounding a second portion of the rod along the longitudinal axis of the rod, such that the slide hammer contacts a stopper mounted at a proximal end of the rod, thereby generating an axial force in a proximal direction of the rod.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example exploded view of a conventional valve assembly;

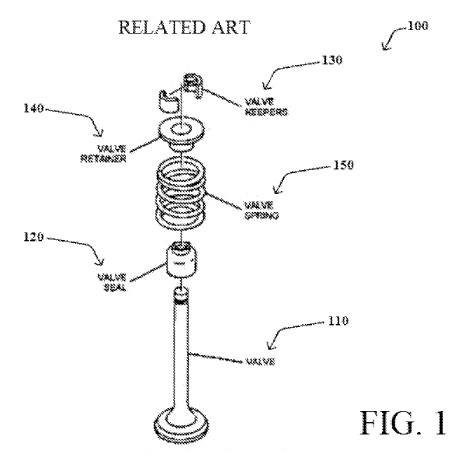

FIG. 2 illustrates an example profile view of a valve seal removal tool;

FIGS. 3A and 3B illustrate example views of a collet and a collet holder fitted over the collet; and

FIG. 4 illustrates an example cross-sectional view of the valve seal removal tool during valve seal extraction.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

It is understood that the term “vehicle” or “vehicular” or other similar term as used herein is inclusive of motor vehicles, in general, such as passenger automobiles including sports utility vehicles (SUV), buses, trucks, various commercial vehicles, watercraft including a variety of boats and ships, aircraft, and the like, and includes hybrid vehicles, electric vehicles, hybrid electric vehicles, hydrogen-powered vehicles and other alternative fuel vehicles (e.g., fuels derived from resources other than petroleum). As referred to herein, an electric vehicle (EV) is a vehicle that includes, as part of its locomotion capabilities, electrical power derived from a chargeable energy storage device (e.g., one or more rechargeable electrochemical cells or other type of battery). An EV is not limited to an automobile and may include motorcycles, carts, scooters, and the like. Furthermore, a hybrid vehicle is a vehicle that has two or more sources of power, for example both gasoline-based power and electric-based power (e.g., a hybrid electric vehicle (HEV)).

The term “user” may encompass any person substantially capable of interacting with the valve seal removal tool disclosed herein.

Referring now to embodiments of the present disclosure, the disclosed techniques a tool for assisting in the removal of valve stem seals. The valve seal removal tool disclosed herein can be fitted over a valve guide for efficient extraction of a valve seal (e.g., in an internal combustion engine). The valve seal removal tool is capable of being operated by hand and does not use any gears. Instead, the tool uses compression to hold the valve seal tightly. A nut (e.g., flange nut) is used to apply force to a collet holder surrounding a threaded rod which compresses a collet onto the outer circumference of a valve seal. Then, a slide hammer is used to apply force in the opposite direction to extract the valve seal.

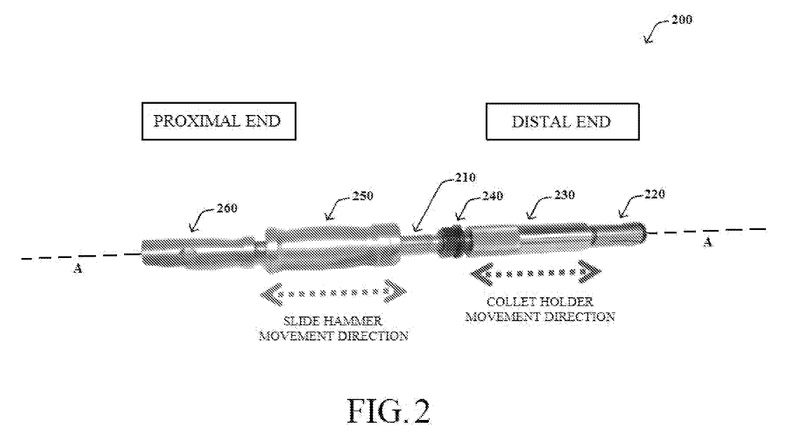

FIG. 2 illustrates an example profile view of a valve seal removal tool. As shown in FIG. 2, the valve seal removal tool 200 includes a proximal end (e.g., at the stopper 260) and a distal end (e.g., at the collet 220). For the purposes of the present disclosure, the terms “proximal end” and “distal end” with respect to the valve seal removal tool 200, or the individual components thereof, refer to the orientation depicted in FIG. 2.

The valve seal removal tool 200 includes an elongated, threaded rod 210 to which multiple components are coupled, either movably or stationarily. A longitudinal axis along which the rod 210 extends is shown in FIG. 2 (e.g., longitudinal axis ‘A’). The rod 210 may act as a drawbar in the valve seal removal tool 200 by providing a solid coupling between an axial force generated in the proximal direction of the rod 210 (e.g., from the slide hammer 250) and a valve seal to be extracted. The rod 210 may be threaded to accommodate particular components, such as the nut 240, for example.

A collet 220 is connected to the rod 210 at the distal end of the rod 210. The collet 220 may extend longitudinally along the longitudinal axis A of the rod 210. The collet 220 may have a substantially cylindrical inner surface, and the inner circumference of the collet 220 may be capable of being fitted over an outer circumference of a valve seal (e.g., valve seal 120). As such, the collet 220 may form a collar around the valve seal and exert a strong clamping force on the valve seal when it is compressed, thus tightening the collar, as described in further detail below.

A collet holder 230 is coupled to the rod 210 so as to surround a first portion of the rod 210 and extends longitudinally along the longitudinal axis A of the rod 210. The collet holder 230 may be movable along the longitudinal axis A of the rod 210. The collet holder 230 may be positioned on the rod 210 substantially to the proximal side of the collet 220. That is, a substantial portion of the collet holder 230 may be positioned on the rod 210 proximally to the collet 220. Additionally, the collet holder 230 may have a cylindrical outer surface and a cylindrical inner surface with an inner circumference capable of being fitted over an outer circumference of a proximal end of the collet 220. Thus, the collet holder 230 can move in a distal direction of the rod 210 over an outer surface portion of the collet 220, effectively acting as a sleeve for the collet 220.

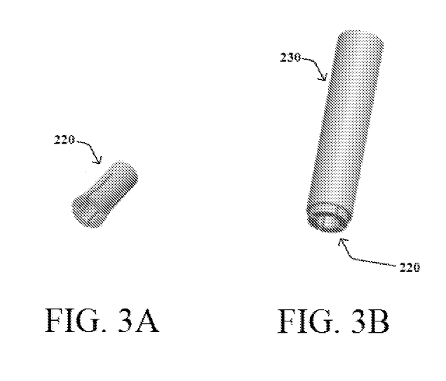

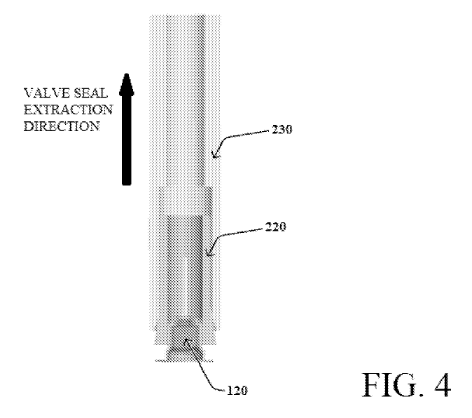

When the collet holder 230 is moved over the outer surface portion of the collet 220, the collet 220 can be radially compressed. In this regard, FIGS. 3A and 3B illustrate example views of a collet and a collet holder fitted over the collet. A component-level view of the collet 220 is shown in FIG. 3A. The collet 220 may have 1) a cylindrical proximal outer portion that allows the collet holder 230 to move over the outer circumference of the proximal end the collet 220, and 2) a conical distal outer portion that allows for compression of the collet 220 and contraction of its inner circumference. As shown in FIG. 3B, compression of the collet 220 may occur when the collet holder 230 moves in the distal direction of the rod 210 over the collet 220, and an inner distal surface of the collet holder 230 abuts the conical distal outer portion of the collet 220. In order to facilitate compression of the collet 220, the collet holder 230 may be formed with a tapered inner surface at a distal end thereof (however, a tapered inner distal surface is not necessary, and the collet holder may instead have a cylindrical inner distal surface). The inner distal surface of the collet holder 230 may be tapered such that a thickness of a wall portion at a distal end of the tapered inner surface is less than a thickness of a wall portion at a proximal end of the tapered inner surface (the tapered inner distal surface of the collet holder 230 is depicted in the cross-sectional view of FIG. 4). Furthermore, the tapered inner surface of the collet holder 230 may correspond to the tapered outer surface (i.e., the conical distal outer portion) of the collet 220. Therefore, as shown in FIG. 3B, the collet holder 230 can cover an outer portion (i.e., cylindrical proximal outer portion) of the collet 220 as the collet holder 230 moves distally along the longitudinal axis A, and the inner distal surface of the collet holder 230 may slide onto the conical distal outer portion of the collet 220. As the collet holder 230 slides onto the conical distal outer portion of the collet 220, the collet 220 compresses, making the inner distal surface of the collet 220 contract to a slightly smaller diameter. This compression of the collet 220 allows its inner surface to firmly squeeze an object fitted therein, such as a valve seal.

Referring again to FIG. 2, a threaded nut 240 is coupled to the rod 240 at a proximal side of the collet holder 230. The distal end of the nut 240 may oppose the proximal end of the collet holder 230. The nut 240 may be a flange nut, where a flange portion is formed at the distal end of the nut 240 that opposes the proximal end of the collet holder 230. In the alternative, a washer may be positioned adjacently to the nut 240 on the rod 210. Additionally, the nut 240 may be tightened in the distal direction of the rod 210 (e.g., by a user turning the nut 240 in a clockwise manner). As the nut 240 is tightened in the distal direction, the distal end of the nut 240 comes into contact with the proximal end of the collet holder 230, forcing the collet holder 230 to move in the distal direction of the rod 210 over an outer portion of the collet (e.g., as shown in FIG. 3B). Continued tightening of the nut 240 in the distal direction generates additional force against the distal end of the collet holder 230 and causes the collet holder 230 to abut the conical outer surface portion of the collet 220 which compresses the collet 220. Therefore, the degree of compression of the collet 220 can be controlled based on the amount by which the nut 240 is tightened in the distal direction against the collet holder 230.

A slide hammer 250 is coupled to the rod 210 so as to surround a second portion of the rod 210. The slide hammer 250 represents a weighted object that can slide along the rod 210 along the longitudinal axis A and impart an axial force upon contacting an object mounted at an end of the rod 210 (e.g., stopper 260). The slide hammer 250 may be positioned at a proximal side of the nut 240 and collet holder 230, such that the distal end of the slide hammer 250 opposes the proximal end of the nut 240. The proximal end of the slide hammer 250 may oppose a stopper 260 mounted at the proximal end of the rod 210. Thus, the proximal end of the slide hammer 250 can slidably contact the stopper 260 (e.g., by a user sliding the slide hammer 250 in a proximal direction of the rod 210). When the slide hammer 250 is caused to slidably contact the stopper 260, an axial force can be generated in the proximal direction of the rod 210. As a result, the slide hammer 250 transmits an impact force to the valve seal, which is simultaneously being compressed by the collet 220, without striking the valve seal itself. The impact force generated as the slide hammer 250 comes into contact with the stopper 260 pulls at the valve seal in the proximal direction in order to remove the valve seal from the valve stem (e.g., valve 110) to which it is attached.

FIG. 4 illustrates an example cross-sectional view of the valve seal removal tool during valve seal extraction. As shown in FIG. 4, a user can use the valve seal removal tool 200 to extract the valve seal 120 in the proximal direction of the rod 210. In order to extract the valve seal 120, the valve seal removal tool 200 first engages the valve seal 120. To this end, the collet 220 is fitted over the outer circumference of the valve seal 120. Then, the nut 240 can be tightened in the distal direction of the rod 210 against the collet holder 230, forcing the collet holder 230 to move in the distal direction over the collet 220. As the collet holder 230 moves distally, the collet 220 is drawn into the collet holder 230, thereby compressing collet 220 around the valve seal 220. Once the valve seal 120 is engaged, the slide hammer 250 can be forcibly slid along the rod 210 against the stopper 260 to generate an axial force in the proximal direction (i.e., the direction of valve seal extraction). Consequently, the valve seal 120 can be safely and efficiently extracted from the valve assembly 100.

Accordingly, the valve seal removal tool described herein enables rapid removal of valve stem seals by creating the force necessary to grip the valve stem seals through the compression of a collet and utilizing axial force generated by a slide hammer operably coupled to the collet. The valve seal removal tool can reduce the time needed to remove each valve seal, so that valves can be removed more efficiently. As a corollary, fatigue of technicians can be reduced allowing the technicians to be more productive. Moreover, damage to the cylinder head from improper use of the conventional tools can be prevented.

While there have been shown and described illustrative embodiments that provide for a cabin temperature setting and display method and system, it is to be understood that various other adaptations and modifications may be made within the spirit and scope of the embodiments herein. For example, the embodiments have been primarily shown and described herein with relation to removal of a valve seal. However, the embodiments in their broader sense are not as limited. Rather, the devices and techniques described herein may be applied to other components, allowing for the efficient removal of other components, as well. Thus, the embodiments may be modified in any suitable manner in accordance with the scope of the present claims.

The foregoing description has been directed to embodiments of the present disclosure. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A valve seal removal tool comprising:
an elongated, threaded rod having a stopper mounted at a proximal end of the rod and a collet connected to a distal end of the rod that longitudinally extends along a longitudinal axis of the rod, an inner circumference of the collet capable of being fitted over an outer circumference of a valve seal;
a collet holder surrounding a first portion of the rod, positioned substantially to a proximal side of the collet, and longitudinally extending along the longitudinal axis of the rod, the collet holder being movable along the longitudinal axis of the rod and having an inner circumference capable of being fitted over an outer circumference of a proximal end of the collet;
a threaded nut coupled to the rod and having a distal end that opposes a proximal end of the collet holder; and
a slide hammer surrounding a second portion of the rod and being slidable along the longitudinal axis of the rod, the slide hammer having a distal end that opposes the nut and a proximal end that opposes the stopper and is operable to slidably contact the stopper, thereby generating an axial force in a proximal direction of the rod,
wherein tightening the nut in a distal direction of the rod causes the distal end of the nut to contact the proximal end of the collet holder, forcing the collet holder to move in the distal direction of the rod over a portion of the collet which compresses the collet.

2. The valve seal removal tool of claim 1, wherein the collet holder is formed with a tapered inner surface at a distal end thereof.

3. The valve seal removal tool of claim 2, wherein the tapered inner surface is formed such that a thickness of a wall portion at a distal end of the tapered inner surface is less than a thickness of a wall portion at a proximal end of the tapered inner surface.

4. The valve seal removal tool of claim 2, wherein a surface angle of the tapered inner surface corresponds to a surface angle of a tapered outer surface portion of the collet.

5. The valve seal removal tool of claim 1, wherein when the collet holder is forced to move in the distal direction of the rod, an inner distal surface of the collet holder abuts an outer surface of the collet which compresses the collet.

6. The valve seal removal tool of claim 5, wherein the outer surface of the collet abutted by the inner distal surface of the collet holder is conically shaped.

7. The valve seal removal tool of claim 1, wherein the collet holder has a cylindrical outer surface.

8. The valve seal removal tool of claim 1, wherein the collet has a cylindrical proximal outer portion and a conical distal outer portion.

9. The valve seal removal tool of claim 1, wherein the collet has a cylindrical inner surface.

10. The valve seal removal tool of claim 1, wherein the nut is a flange nut.

11. The valve seal removal tool of claim 10, wherein a flange portion is formed at the distal end of the nut that opposes the proximal end of the collet holder.

12. A valve seal removal system comprising:
a valve assembly including a valve seal connected to a valve; and
a valve seal removal tool including:
an elongated, threaded rod having a stopper mounted at a proximal end of the rod and a collet connected to a distal end of the rod that longitudinally extends along a longitudinal axis of the rod, an inner circumference of the collet capable of being fitted over an outer circumference of the valve seal;
a collet holder surrounding a first portion of the rod, positioned substantially to a proximal side of the collet, and longitudinally extending along the longitudinal axis of the rod, the collet holder being movable along the longitudinal axis of the rod and having an inner circumference capable of being fitted over an outer circumference of a proximal end of the collet;
a threaded nut coupled to the rod and having a distal end that opposes a proximal end of the collet holder; and
a slide hammer surrounding a second portion of the rod and being slidable along the longitudinal axis of the rod, the slide hammer having a distal end that opposes the nut and a proximal end that opposes the stopper and is operable to slidably contact the stopper, thereby generating an axial force in a proximal direction of the rod,
wherein tightening the nut in a distal direction of the rod causes the distal end of the nut to contact the proximal end of the collet holder, forcing the collet holder to move in the distal direction of the rod over a portion of the collet which compresses the collet onto the outer circumference of the valve seal.

13. A method for removing a valve seal comprising:
fitting an inner circumference of a collet over an outer circumference of the valve seal, the collet being connected to a distal end of an elongated, threaded rod and longitudinally extending along a longitudinal axis of the rod;
tightening a threaded nut coupled to the rod in a distal direction of the rod toward a collet holder surrounding a first portion of the rod and longitudinally extending along the longitudinal axis of the rod, such that the nut contacts a proximal end of the collet holder, forcing the collet holder to move in the distal direction of the rod over a portion of the collet which compresses the collet onto the outer circumference of the valve seal; and
sliding a slide hammer surrounding a second portion of the rod along the longitudinal axis of the rod, such that the slide hammer contacts a stopper mounted at a proximal end of the rod, thereby generating an axial force in a proximal direction of the rod.
